(19) United States
(12) Patent Application Publication
(10) Pub. No.: US 2009/0048773 A1
(43) Pub. Date: Feb. 19, 2009

(54) PERSONALISED MAPS

(75) Inventors: Heli Jarventie, Tampere (FI); Nina Maaninka, Tampere (FI); Riitta Jokela, Ramsoo (FI); Jussi A. Suojanen, Tampere (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 12/191,606

(22) Filed: Aug. 14, 2008

Related U.S. Application Data
(60) Provisional application No. 60/956,511, filed on Aug. 17, 2007.

(51) Int. Cl. G01C 21/00

(52) U.S. Cl. 701/201

(57) ABSTRACT

A method in a mobile communication device, including acquiring positioning information representing a geographical location; calculating data representing a first route from the acquired positioning information, the first route having a starting point, a current point, and an ending point; storing data representing the first route; capturing a first set of content information including components of contents information and associating the components of content information with components of the acquired positioning information; associating the first route with the first set of content information; and storing data representing an association of the components of the first set of captured content information and the components of acquired positioning information is provided. A device, server and system thereof is also provided.

### CROSS REFERENCE TO RELATED APPLICATION

This application claims the benefit of, and priority to, U.S. Provisional Patent Application Ser. No. 60/956,511, filed on Aug. 17, 2007, the disclosure of which is incorporated herein by reference in its entirety.

### TECHNICAL FIELD

The disclosed embodiments relate to a method for creating personalised maps in a mobile communication device and a device, server and system thereof.

### BACKGROUND

Mobile communication devices, such as mobile phones or personal digital assistants (PDAs), are today used for many different purposes. In addition to having functions for voice and text communications many of today's mobile communication devices also incorporate digital cameras and voice recorders. These multimedia functionalities allow the user to take pictures, record video clips, or to record voice or text messages for later viewing or listening.

However, as the number of such stored multimedia content increase it gets increasingly difficult for the user to handle the stored multimedia content. The user may easily e.g. forget associations between multiple multimedia content of the same or different kind. This fact causes problems for later viewing and or listening. Another problem is the limited storage capabilities of today's mobile communication devices. The multimedia content can later be transmitted to another mobile communication device or downloaded to a computer and stored, e.g., on said computer or a on web server, to be viewed at or listened to by other users. At the computer, or server, or mobile communication device, the user may also edit the multimedia content, e.g., by adding text comments to a digital picture, by using a specific editing software. However the problem of finding associations amongst the multimedia contents still remains.

Although some of the mobile communication devices also comprise means, such as Global Positioning System (GPS) devices, for geographical navigation, up to the present their potential possibilities have only been subject of insignificant examination. EP 0,833,494 discloses a method wherein the identification information of a mobile base station is used for position information purposes. In more detail, if the received identification information is stored when an image is captured, position information corresponding to the stored identification information is added to the image data. A drawback with the method in EP 0,833,494 is that it does not provide a user of a mobile device with an enhanced capability of utilising the plurality of function features for handling of information of different types and formats in a modern communication device.

### SUMMARY

In view of the above, the aspects of the disclosed embodiments solve or at least reduce the problems discussed above. In particular, the aspects of the disclosed embodiments provide a method for creating personalised maps in a mobile communication device.

Hence there is provided a method in a mobile communication device, comprising acquiring positioning information representing a geographical location; calculating data representing a first route from said acquired positioning information, said first route having a starting point, a current point, and an ending point; storing data representing said first route; capturing a first set of content information comprising components of contents information and associating said components of content information with components of said acquired positioning information; associating said first route with said first set of content information; and storing data representing an association of said components of said first set of captured content information and said components of acquired positioning information. Said components of captured content information may consist of a holistic unit comprising a combination of one or more items from the list: image, video, text, sound.

Such a method makes it possible to create personalised maps in a mobile communication device and hence is an important improvement over prior art methods at least in that a traceable route is created whilst content information is captured, wherein said captured content information may be a holistic unit of different types of content information, and that said captured content information is directly associated with said traceable route.

Said method may further comprise acquiring a second route, wherein said second route is associated with a second set of captured content information.

Such an added technical feature also provides an important improvement over prior art methods at least in that it makes possible to indicate at least two routes with associated sets of captured content information simultaneously.

Said method may further comprise receiving a pre-defined map; indicating at least one of present routes on said pre-defined map thereby creating a personalised map; indicating said at least one set of content information of said at least one route and said components of acquired positioning information together on said personalised map; and storing said personalised map. Said at least one route may be calculated from a combination of said positioning information and information provided by said pre-defined map. Furthermore, said personalised map may have two or three dimensions.

Hence the method provides a way to creating a personalised map consisting of a pre-defined map and on said pre-defined map indicating at least one route with associated set of captured content information. This is also an improvement over prior art methods in that several routes with associated sets of content information may be viewed simultaneously. The personalised map may also be stored for later retrieval and viewing.

The method may further also comprise on said personalised map indicating a current position and said components of said at least on set of content information along said at least one route on said personalised map when said components of acquired positioning information of said content information correspond to said current position. A distance from the starting point to the ending point of said at least one route, and indicating a distance from the starting point to the current position of said at least one route may also be indicated. Hence it is provided a method which enables easy navigation on said personalised map.

Thus one advantage with the disclosed method is that it makes it possible for a user to trace the exact geographical route between different image capturing occasions. Another advantage with the disclosed method is that it allows users to edit and to combine different components of their multimedia content on-the-fly. Yet another advantage is that it allows different users to combine their multimedia content with each other's to form personalised maps having at least one route.

Another aspect of the disclosed embodiments is to provide a mobile communication device, comprising circuitry configured to receive positioning information representing a geographical location; calculate data representing a first route from said received positioning information, said first route having a starting point, a current point, and an ending point; store data representing said first route; capture a first set of content information comprising components of contents information and associating said components of content information with components of said received positioning information; associate said first route with said first set of content information; and store data representing an association of said components of said first set of captured content information and said components of acquired positioning information. The mobile communication device may further comprising circuitry configured to receive a second route, wherein said second route is associated with a second set of captured content information.

The mobile communication device may further comprise circuitry configured to receive a pre-defined map; indicate at least one of present routes on said pre-defined map thereby creating a personalised map; indicate said at least one set of content information of said at least one route and said components of captured positioning information together on said personalised map; and store said personalised map.

A further aspect of the disclosed embodiments is to provide a method in a server for processing personalised maps, comprising providing positioning information to a mobile communication device; providing a pre-defined map to a mobile communication device; receiving at least one route from said mobile communication device; receiving at least one set of holistic units of captured content information associated with said positioning information from said mobile communication device, said content information comprising a combination of one or more items from the list: image, video, text, sound; associating said pre-defined map, said received at least one route, and received said at least one set of holistic units of captured content information to form a personalised map; sharing said personalised map between said mobile communication device and one or more devices, from the list: a mobile communication device, a computer; and combining at least one personalised map into one single cardinal personalised map. The method in a server for personalised maps may further comprise indicating said at least one personalised map on a display.

At least one mobile communication device capable of creating personalised maps and at least one server comprising circuitry to perform said method in a server will together with a communications system thus provide a system for communicating personalised maps according to yet another aspect of the disclosed embodiments. Said communications system facilitates the communication between said at least one mobile communication device and said at least one server.

With such as system personalised maps may easily be communicated from a mobile communication device to another mobile communication device, from a mobile communication device to a computer or a server, from a computer or a server to a mobile communication device, or from a computer or a server to another computer or another server.

There is also provided a computer program product, comprising computer program code stored on a computer-readable storage medium which, when executed on a processor, carries out a method to create personalised maps as described above, and a computer program product, comprising computer program code stored on a computer-readable storage medium which, when executed on a processor, carries out a method in a server as described above.

Other aspects, features and advantages of the disclosed embodiments will appear from the following detailed disclosure, from the attached dependent claims as well as from the drawings.

### BRIEF DESCRIPTION OF THE DRAWINGS

The above, as well as additional aspects, features and advantages of the disclosed embodiments, will be better understood through the following illustrative and non-limiting detailed description of preferred embodiments, with reference to the appended drawings, where the same reference numerals will be used for similar elements, wherein:

FIG. 1 is a schematic illustration of a cellular telecommunication system, as an example of an environment in which the disclosed embodiments may be applied.

FIG. 2 is a schematic front view illustrating a mobile communication device according to an embodiment.

FIG. 3 is a schematic block diagram representing an internal component, software and protocol structure of the mobile terminal shown in FIG. 2.

FIG. 4 is a flow chart illustrating a method for creating personalised maps according to an embodiment.

FIG. 5 is a flow chart illustrating a method for creating personalised maps according to another embodiment.

FIGS. 6a-c are schematic display views of two-dimensional personalised maps according to different embodiment.

FIG. 7 is a schematic display view of a two-dimensional personalised map according to an embodiment.

FIG. 8 is a schematic display view of a three-dimensional personalised map according to another embodiment.

FIG. 9 is a flow chart illustrating a method in a mobile communication device for creating or loading personalised maps according to an embodiment.

FIG. 10 is a flow chart illustrating a method for loading personalised maps to an application according to an embodiment.

### DETAILED DESCRIPTION OF PREFERRED EMBODIMENTS

The disclosed embodiments have mainly been described above with reference to a few embodiments. However, as is readily appreciated by a person skilled in the art, other embodiments than the ones disclosed above are equally possible within the scope of the disclosed embodiments, as defined by the appended patent claims.

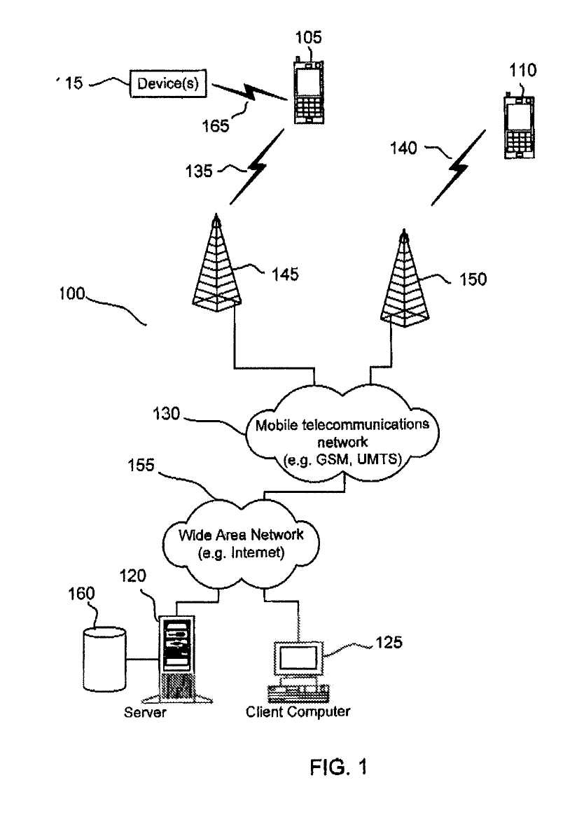

FIG. 1 illustrates an example of a cellular telecommunications system 100 in which the disclosed embodiments may be applied. In the telecommunication system 100 of FIG. 1, various telecommunications services such as cellular voice calls, www/wap browsing, cellular video calls, data calls, facsimile transmissions, music transmissions, still image transmissions, video transmissions, electronic message transmissions, electronic positioning information, and electronic commerce may be performed between a mobile communication device 105 according to the disclosed embodiments and other devices, such as another mobile communication device 110, a local device 115, or a computer 120, 125. It is to be noted that for different embodiments of the mobile terminal 105 and in different situations, different ones of the telecommunications services referred to above may or may not be available; the disclosed embodiments are not limited to any particular set of services in this respect.

The mobile communication devices 105, 110 are connected to a mobile telecommunications network 130 through RF links 135, 140 via base stations 145, 150. The base stations 145, 150 are operatively connected to the mobile telecommunications network 130. The mobile telecommunications network 130 may be in compliance with any commercially available mobile telecommunications standard, such as GSM, UMTS, D-AMPS, CDMA2000, FOMA and TD-SCDMA.

The mobile telecommunications network 130 is operatively connected to a wide area network 155, which may be Internet or a part thereof. An Internet server 120 has a data storage 160 and is connected to the wide area network 155, as is an Internet client computer 125. The server 120 may host a www/wap server capable of serving www/wap content to the mobile communication devices 105, 110. The server 120 may also be able to process personalised maps according to different embodiments. It might also provide a plurality of the following services: providing positioning information to a mobile communication device 105, 110; providing a pre-defined map to a mobile communication device 105, 110; receiving information associated with a personalised map from a mobile communication device 105, 110; and sharing said personalised map among different devices and one or more devices, from the list: a mobile communication device 105, 110, a local device 115, a computer 125; and combining at least one personalised map into one single cardinal personalised map.

The mobile communication device 105 is also capable of communicating locally via a local link 165 to one or more local devices 115. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, and communications aided by the infrared data association (IrDA) standard, etc.

At least one mobile communication device 105 capable of creating personalised maps and at least one server 120 comprising circuitry to perform said method in a server 120 will together with a communications system 100 thus provide a system for communicating personalised maps according to one aspect of the disclosed embodiments. Said communications system 100 facilitates the communication between said at least one mobile communication device 105 and said at least one server 120.

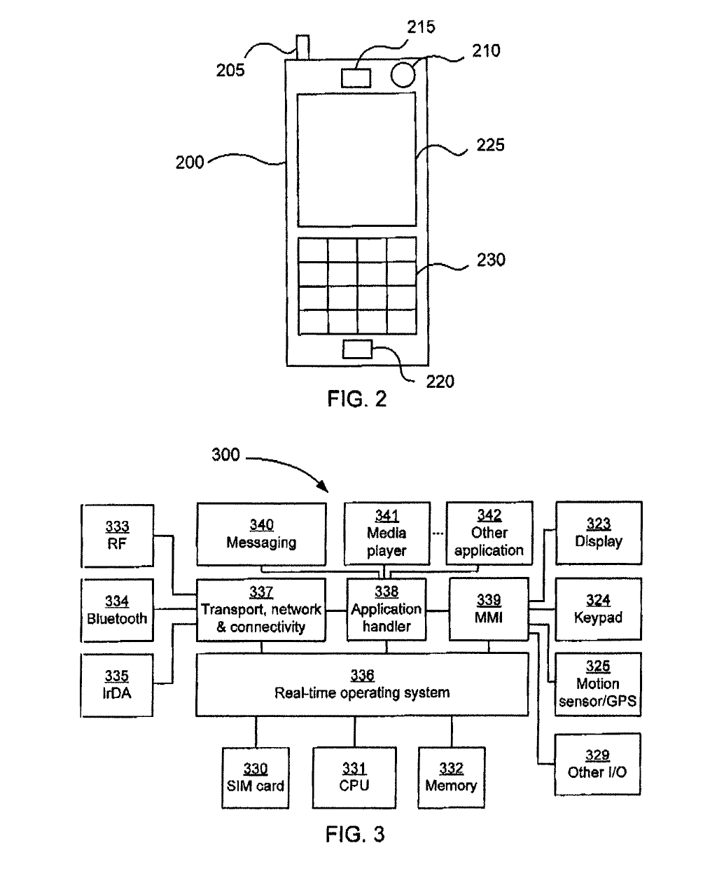

An embodiment 200 of the mobile communication device 105 is illustrated in more detail in FIG. 2. The mobile communication device 200 comprises an antenna 205, a camera 210, a speaker or earphone 215, a microphone 220, a display 225 and a set of keys 230 which may include a keypad of common ITU-T type (alpha-numerical keypad representing characters “0”-“9”, “*” and “#”) and certain other keys such as soft keys, and a joystick or other type of navigational input device (not explicitly illustrated). The mobile communication device 200 may be e.g. a mobile phone or a personal digital assistant (PDA).

The internal components 300, software and protocol structures of the mobile communication device 200 will now be described with reference to FIG. 3. The mobile communication device has a controller 331 which is responsible for the overall operation of the mobile terminal and is preferably implemented by any commercially available CPU (“Central Processing Unit”), DSP (“Digital Signal Processor”) or any other electronic programmable logic device. The controller 331 has associated electronic memory 332 such as RAM memory, ROM memory, EEPROM memory, flash memory, or any combination thereof. The memory 332 is used for various purposes by the controller 331, one of them being for storing data and program instructions for various software in the mobile terminal. The software includes a real-time operating system 336, drivers for a man-machine interface (MMI) 339, an application handler 338 as well as various applications. The applications can include a messaging application 340 for sending and receiving SMS, MMS or email, a media player application 341, as well as various other applications 342, such as applications for voice calling, video calling, web browsing, an instant messaging application, a phone book application, a calendar application, a control panel application, a camera application, one or more video games, a notepad application, a positioning application, etc.

The MMI 339 also includes one or more hardware controllers, which together with the MMI drivers cooperate with the display 323, 225, keypad 324, 230, motion sensor 325, such as an accelerometer or a GPS, as well as various other I/O devices 329 such as microphone 220, speaker 215, vibrator, ringtone generator, LED indicator, etc. As is commonly known, the user may operate the mobile terminal through the man-machine interface thus formed.

The software also includes various modules, protocol stacks, drivers, etc., which are commonly designated as 337 and which provide communication services (such as transport, network and connectivity) for an RF interface 333, and optionally a Bluetooth interface 334 and/or an IrDA interface 335 for local connectivity. The RF interface 333 comprises an internal or external antenna as well as appropriate radio circuitry for establishing and maintaining a wireless link to a base station (e.g. the link 135 and base station 145 in FIG. 1). As is well known to a person skilled in the art, the radio circuitry comprises a series of analogue and digital electronic components, together forming a radio receiver and transmitter. These components include, e.g., band pass filters, amplifiers, mixers, local oscillators, low pass filters, AD/DA converters, etc.

The mobile communication device 200 as represented by the internal components 300 in FIG. 3 may also have a SIM card 330 and an associated reader. As is commonly known, the SIM card 330 comprises a processor as well as local work and data memory.

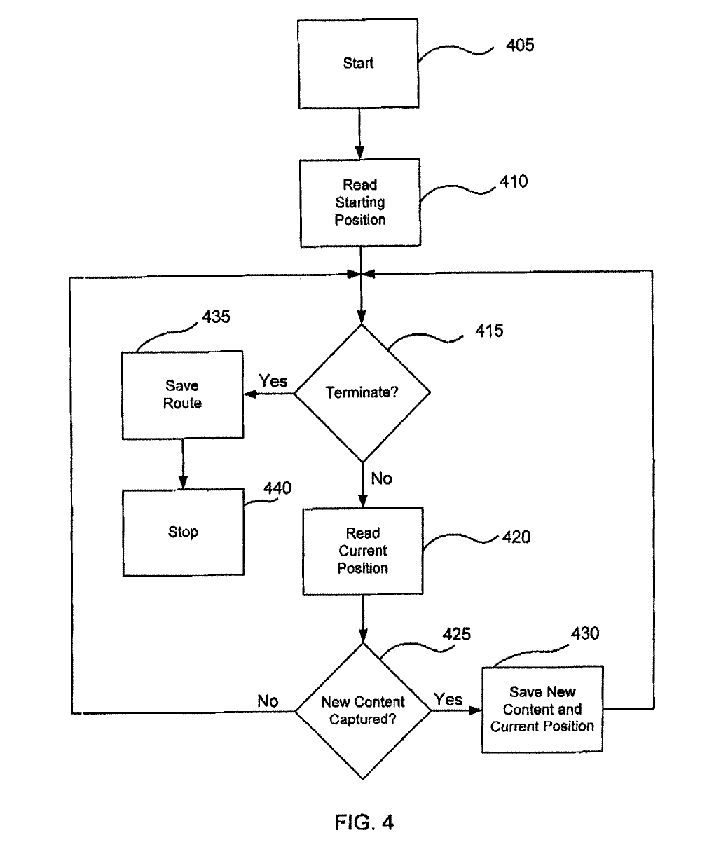

Continuing now with FIG. 4 which shows a flow chart illustrating a method in a mobile communication device 105, 200 according to an embodiment. After a start sequence 405 has been initialised to start the application, e.g. by a user pressing a combination of keys on the keypad 230 in FIG. 2, a starting position, e.g. a position corresponding to a geographical location, is acquired 410. Said starting position may be captured by e.g. a positioning system, such as the global positioning system (GPS), present in the mobile communication device 105, 200 or it may be acquired e.g. from a local device 115 or from the network 130.

If a termination sequence 415 is not initialised a new current position is acquired 420 by the mobile communication device 105, 200. Said starting position and said new current position will thus form the end points of a route, said route having a distance measurable between said starting position and said new current position.

A sequence of captured current positions forms a route. However, due to limitation on resolution of the positioning information said route may or may not correspond to e.g. a road or a path on said pre-defined map. The result may e.g. be a situation in which a route, as acquired 410 by the mobile communication device 105, 200 will appear to be obviously unfeasible on said pre-defined map. As is known to a person skilled in the art a solution to this problem might be to use specific computer software which automatically associates said route with a road or a path from a candidate set of possible roads and paths as provided by the pre-defined map.

If content is not captured 425 another new current position is acquired 420 by the mobile communication device 105, 200. Said starting position and said new current position will thus form the new end points of said route, said route having a distance measurable between said starting position and said new current position. Hence the total distance from the starting point to the ending point is incremented with the distance from the “old” current position to the “new” current position.

If content is captured 425 said content being e.g. a holistic unit comprising a component or a combination of one or more items from the list: image, video, text, sound, said content may be associated with said current position. The content may then be saved 430 together with said current position and said distance along the route from said starting position to said current position in e.g. a local memory 332 of the mobile communication device 105, 200, 300, in a local device 115, in a computer 125, or in a memory 160 of a server 120.

If a termination sequence is not initialised 415 another new current position is acquired 420 by the mobile communication device 105, 200.

If a termination sequence is initialised 415 e.g. by a user pressing a combination of keys on the keypad 230 in FIG. 2, the ending point of the route is defined as the latest captured new current position. The route from the starting point to the ending point may be thought of as a traceable map. The route may be saved 435, in e.g. a local memory 332 of the mobile communication device 105, 200, 300, in a memory of a local device 115, in a memory of a computer 125, or in a memory 160 of a server 120. The personalised map creating application may then be closed 440.

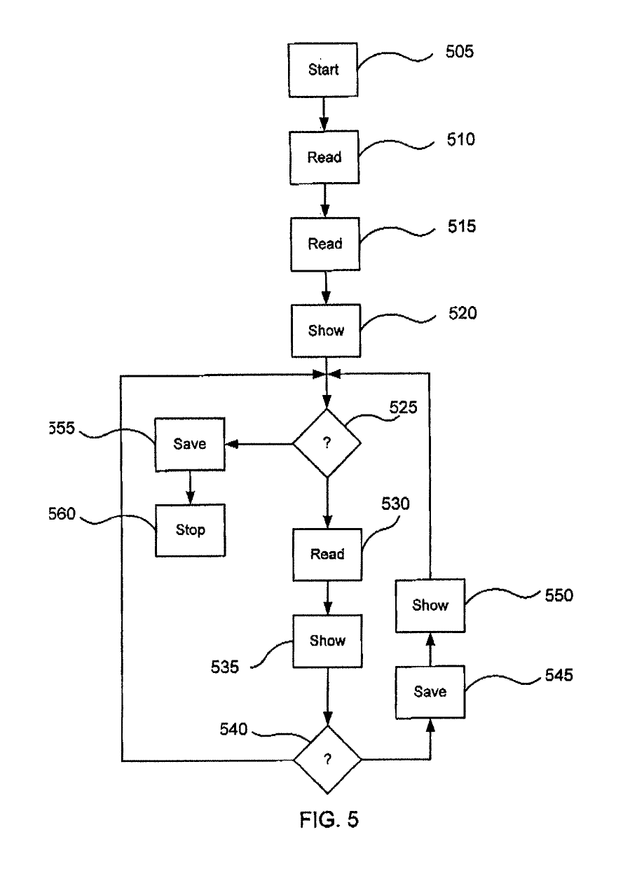

FIG. 5 shows a flow chart illustrating a method in a mobile communication device 105, 200 according to an embodiment having additional features compared to the method illustrated in the flow chart in FIG. 4 described above.

According to one embodiment, after a start sequence has been initialised 505 to start the application, e.g. by a user pressing a combination of keys on the keypad 230 in FIG. 2, a starting position, e.g. a position corresponding to a geographical location, is acquired 510. The mobile communication device 105, 200, may further receive 515 a pre-defined map e.g. from a server 120, or from a mobile communication device 110 or from a local device 115 as in FIG. 1. With such a pre-defined map at hand said starting position may be indicated on said pre-defined map and displayed 520 on a display window 225 of the mobile communication device 105, 200.

Similarily to steps 415 and 420 in FIG. 4, if a termination sequence 525 is not initialised a new current position is acquired 530 by the mobile communication device 105, 200.

If a pre-defined map has been received 515 said new current position may also be indicated on said pre-defined map and displayed 535 on a display window 225 of the mobile communication device 105, 200. According to one embodiment said route may also be indicated on said pre-defined map and displayed 535 on a display window 225 of the mobile communication device 105, 200.

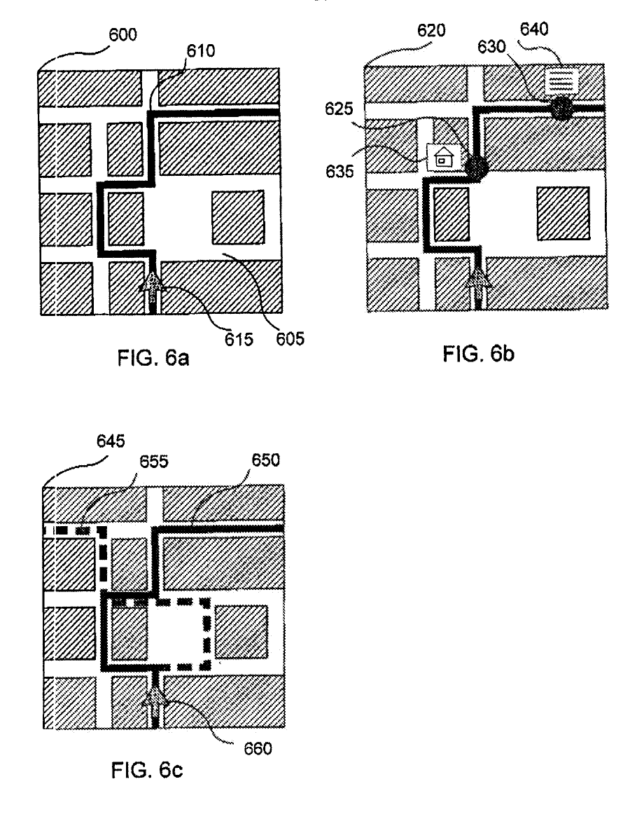

In one embodiment said distance of said route may also be indicated on said pre-defined map and displayed 535 on a display window 225 of the mobile communication device 105, 200. Said pre-defined map and said route will thus form a personalised map. More details regarding displaying personalised maps on a display will be given below with reference to FIGS. 6a-6c, 7, and 8.

Similarily to step 425 in FIG. 4, if content is not captured 540 another new current position is acquired 530 by the mobile communication device 105, 200

Similarily to steps 425 and 430 in FIG. 4, if content is captured 540 it may be saved 545 together with said current position and said distance along the route.

In one embodiment said content may also be indicated on said pre-defined map and displayed 550 on a display window 225 of the mobile communication device 105, 200. The content may be indicated at said current position of said pre-defined map as an icon, wherein said icon distinguishes between different types of contents, e.g. images, video clips, text messages, sounds, and displayed 550 on a display window 225 of the mobile communication device 105, 200. As mentioned above, more details regarding displaying personalised maps on a display will be given below with reference to FIGS. 6a-6c, 7, and 8.

Similarily to steps 415, 435, 440 in FIG. 4, if a termination sequence is initialised 525 the personalised map may be saved 555 and the application may be closed 560.

FIGS. 6a, 6b and 6c illustrate schematic display views of two-dimensional personalised maps according to different embodiments The personalised maps 600, 620, 645 may be part of a man machine interface (MMI) 339 and displayed on the display 225 of the mobile communication device 105, 200, or it may be part of e.g. a web application stored in a memory 160 of a server 120 and displayed on an Internet web site, or it may be part of another multimedia application and displayed on a computer 125.

Focusing now on FIG. 6a, which illustrates a personalised map 600 according to one embodiment. The personalised map 600 includes a pre-defined map 605 which may comprise e.g. streets, buildings, trees, waterways, public communication facilities, landmarks, etc. The personalised map 600 further comprises a route 610 created according to a method represented by the flow charts of FIGS. 4 and 5 as discussed above. The personalised map 600 may also comprise an indicator 615, which indicates a geographical location on the personalised map 600. The indicator 615 may indicate the present geographical position of the device on which the personalised map is displayed (e.g. on a mobile communication device 105, 200, or on a computer 125). That is, in this case the indicator 615 points at the same geographical position as the device on which the personalised map is displayed is present at—in other words, if the indicator 615 points at position “x” then the device on which the personalised map is displayed is also geographically located at position “x”. Alternatively, the indicator 615 may indicate a position corresponding to a location on the map when said map is browsed, which position is independent of the geographical position of the device on which the personalised map is displayed. This is a typical scenario when a personalised map is viewed e.g. on the display of a computer 125. That is, a user is allowed to browse the personalised map 600 by tracking the route 610 independently of the present geographical position of said device on which the personalised map is displayed.

FIG. 6b illustrates a personalised map 620 as in FIG. 6a further comprising indicators 625, 630 of captured content information, and icons 635, 640 representing said captured content information, said captured content information being, e.g. selected from the types: image, video clip, text message, sound. Said content information may also consist of a holistic unit comprising a combination of one or more items from said types. Said type of captured content information may be indicated by a corresponding type of icon, i.e., an icon representing an image if the captured information content is an image, an icon representing a video clip if the captured information content is a video clip, an icon representing a text message if the captured information content is a text message, an icon representing a sound if the captured information content is a sound, an icon representing a holistic unit of captured information content if the captured information content is a holistic unit of captured information content, etc. The icons 635, 640 and/or indicators 625, 630 of captured content information may be clickable, whereby the captured content information may be displayed on the personalised map 620.

FIG. 6c illustrates a personalised map 645 according to one embodiment. In FIG. 6c two distinguishable routes 650, 655 are shown on the personalised map 645. According to one embodiment it may also be possible to associate each individual route 650, 655 with indicators and icons representing captured content information as in FIG. 6b described above. In FIG. 6c 660 represents an indicator for the route 650.

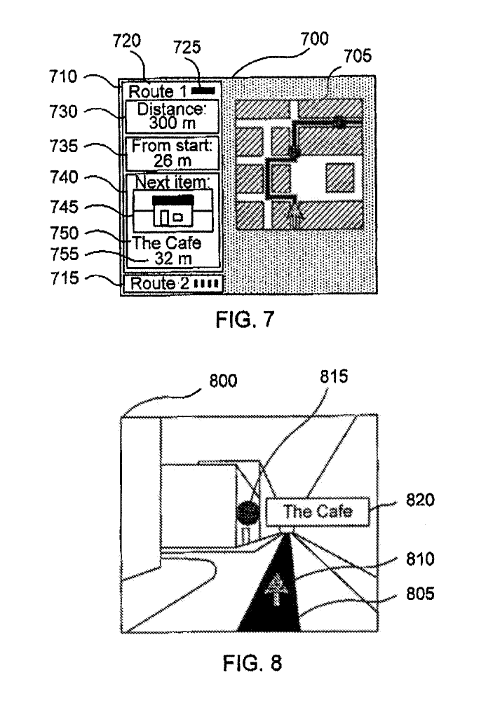

Moving on to FIG. 7 which shows an illustration of, or part of, an exemplary display window for a personalised map application 700. The displayed content comprises a personalised map 705, said personalised map being e.g. any one of the embodiments as described in FIGS. 6a-6c, a control window 710 for a first route on the personalised map 705, and a control window 715 for a second route on the personalised map 705. For illustrative purposes we will consider said second route not to be displayed on the personalised map 705. Focusing on the control window 710 for the first route, which window comprises a name 720 for said first route (in the illustrative example according to FIG. 7 the name is “Route 1”) and a symbol 725 representing said first route to distinguish said first route from other routes which may also be displayed simultaneously on said personalised map 705, a window 730 displaying the total distance from the starting point to the ending point of said route, a window 735 displaying the distance from the starting point to the present point of said route, a window 740 displaying information related to a next captured content information along said route, said window 740 further comprising a representation 745 of said next captured content information, a name tag 750 for said next captured content information (in the illustrative example according to FIG. 7 the name tag is “The Cafe”), and the distance 755 from the present point of said route to the location associated with said next captured content information along said route, said representation 745 being e.g. a thumbnail image of said captured content information if said captured content information is an image, a thumbnail image frame of said captured content information if said captured content information is a video clip, a phrase from a text message of said captured content information if said captured content information is a text message, a first pre-defined symbol if said captured content information is a sound, or a second pre-defined symbol if said captured content information is a holistic unit of captured information content.

The personalised map may also be displayed as a three-dimensional (3D) map. This is illustrated in FIG. 8 which shows an exemplary 3D personalised map 800 comprising a route 805, an indicator 810 of a present location on said map 800, an indicator 815 of captured content information, and a window 820 displaying information related to said captured content information. In this illustrative example the indicator 815 is associated with the location of “The Cafe” as displayed in the window 820 along said route 805.

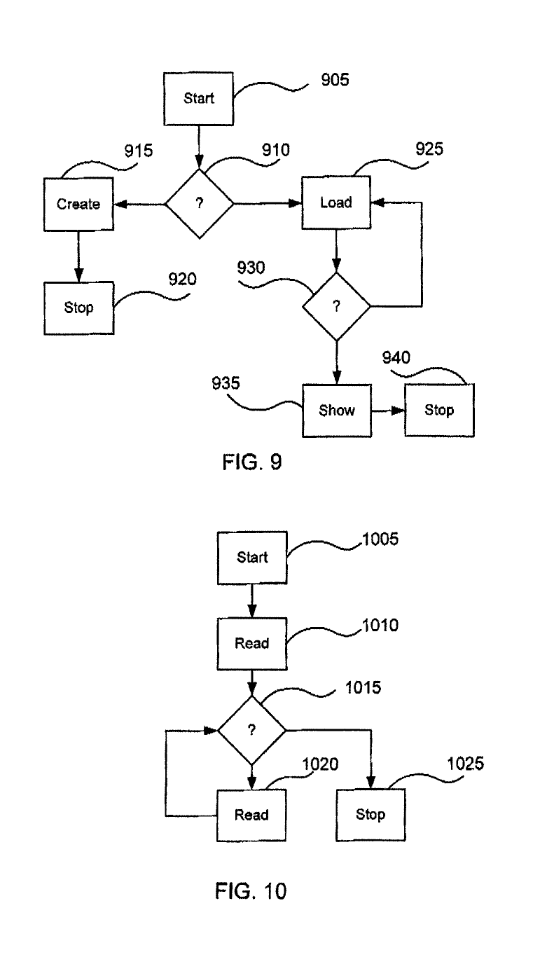

FIG. 9 shows a flow chart illustrating a method in a mobile communication device 105, 200 for creating or loading personalised maps according to an embodiment. After initialising the application 905 the user may choose 910 to create 915 a personalised maps. The process of creating a personalised map may include the steps as illustrated by the flow charts in FIGS. 4-5 as discussed above. When a personalised map has been created the application may be closed 920. If a user instead chooses 910 to load 925 a personalised map a personalised map is loaded. This will be further discussed below with reference to FIG. 10. If a user chooses 930 to load more maps, another map may be loaded 925. If a user chooses 930 not to load more maps the map(s) may be shown 935 on a display screen. After viewing the user may close 940 the personalised map application.

One embodiment of loading personalised maps to an application, as mentioned with reference to step 925 in FIG. 9, will now be described in more detail with reference to the flow chart in FIG. 10. When the process is started 1005 a first route is read 1010. If said read route is associated with content 1015 said content may be read 1020 item by item. If there is no more content to be read 1015 the process is terminated 1025.

Embodiments, as discussed in connection with the figures, will now be further illustrated by using examples representing typical user scenarios.

Scenario 1: (Creating and Sharing a Personalised Map)

Assume a user having access to a mobile communication device 105, 200 comprising software instructions to perform a personalised map application according to the disclosed embodiments. After initialising the personalised map application 405, 505, 905 the user may capture information content 425, 540, 915 whilst e.g. taking a walk. With the aid of a positioning system, such as GPS or positioning information from a base station 145, 150, the personalised map application will thus track the path of said user and hence create a personal route. Whilst walking along said route the user may, for example, capture an image if said mobile communication device 105, 200 comprises an image capturing device, such as a camera. The personalised map application associates said captured image with the location along said route on which location said image is captured by using said positioning system. The user may also add a text caption to said image e.g. by using the keypad 230 of said mobile communication device 105, 200 thus forming a holistic unit of captured content information comprising both an image and a text message. At a different location along said route the user may record a sound clip or a video clip, etc. The different components of captured content information will form a set of captured content information. At the end of the route the user terminates 440, 560, 920 the personalised map application which application will save 435, 555 the route along said set of captured content information. The application may save the route and said set of captured content information together with side information regarding e.g. time and location on which said personalised map was created in e.g. a memory 332 of said mobile communication device 105, 200 in a local device 115 or in a memory 160 of a server 120 for later viewing and/or editing. The user may also choose to share his/her personalised map with other users e.g. by sending the personalised map to other mobile communication devices 110 or by making his/her personalised map available on the Internet or as a wap application by sending it to a computer 125 or a server 120.

Scenario 2: (Viewing at Least One Personalised Map)

Assume a user having access to a mobile communication device 105, 110, 200 or a computer 125 comprising software instructions to receive a personalised map and a display screen for displaying a personalised map as described in FIGS. 6a-6c, 7 and 8. The user may search a data base, which database may either be a local database or a database stored on e.g. a server. The user may search for different personalised maps by entering keywords in a search window or by choosing from a selection of listed personalised maps. The user may select one such personalised map for viewing 935 on said display. According to a first aspect of the current scenario the user may choose to indicate the geographical location of the device on which the application is displayed on said displayed personalised map. For example, if a user uses the personalised map application to follow directions to a specific location he/she will easily follow his/her progression along said route from the starting point to the ending point, e.g. from his/her hotel to a meeting place, wherein said personalised map has been created and distributed by the organisers of said meeting. According to a second aspect of the current scenario the user may view a personalised map e.g. on a computer and browse the personalised map by following the route and clicking on icons representing captured information content along the route. In yet another aspect of the current scenario a user may choose 930 to display several personalised maps as one cardinal personalised map comprising a plurality of routes and associated sets of captured content information. In accordance with this aspect of the current scenario a user may easily overview several routes at once. A typical situation representing this example is a situation in which a user may want a plurality of choices, or opinions, regarding routes with different aspects (e.g. a route from one user indicates museums while another route from the same or a different user indicates restaurants) for the same geographical location.

Generally, all terms used in the claims are to be interpreted according to their ordinary meaning in the technical field, unless explicitly defined otherwise herein. All references to “a/an/said/the [device, component, etc]” are to be interpreted openly as referring to at least one instance of said device, component, etc., unless explicitly stated otherwise. The steps of any method disclosed herein do not have to be performed in the exact order disclosed, unless explicitly stated.

1. A method in a mobile communication device, comprising:
acquiring positioning information representing a geographical location;
calculating data representing a first route from said acquired positioning information, said first route having a starting point, a current point, and an ending point;
storing data representing said first route;
capturing a first set of content information comprising components of contents information and associating said components of content information with components of said acquired positioning information;
associating said first route with said first set of content information; and
storing data representing an association of said components of said first set of captured content information and said components of acquired positioning information.

2. The method according to claim 1, further comprising acquiring a second route, wherein said second route is associated with a second set of captured content information.

3. The method according to claim 1, further comprising:
receiving a pre-defined map;
indicating at least one of said first and said second route on said pre-defined map thereby creating a personalised map;
indicating said at least one set of content information of said at least one route and said components of acquired positioning information together on said personalised map; and
storing said personalised map.

4. The method according to claim 3, further comprising:
acquiring a present position of said mobile communication device; and
indicating on said personalised map said present position of said mobile communication device.

5. The method according to claim 4, further comprising indicating on said personalised map said components of content information along said at least one route on said personalised map when said components of acquired positioning information of said content information correspond to said present position of said mobile communication device.

6. The method according to claim 3, further comprising on said personalised map indicating a position, wherein said position corresponds to said current point of said at least one route while said at least one route is browsed.

7. The method according to claim 6, further comprising on said personalised map indicating said components of said at least one set of content information along said at least one route on said personalised map when said components of acquired positioning information of said content information correspond to said current point of browsing of said at least one route on said personalised map.

8. The method according to claim 1, wherein said acquiring of positioning information comprises any one of acquiring in dependency of timing information, acquiring in dependency of positioning information, acquiring in dependency of motion sensing information.

9. The method according to claim 1, wherein said acquired positioning information is acquired continuously.

10. The method according to claim 3, wherein said at least one route is calculated from a combination of said positioning information and information provided by said pre-defined map.

11. The method according to claim 3, further comprising indicating a distance from the starting point to the ending point of said at least one route.

12. The method according to claim 3, further comprising indicating a distance from the starting point to the current point of said at least one route.

13. The method according to claim 3, wherein said personalised map has two or three dimensions.

14. The method according to claim 1, wherein said capturing of content information comprises capturing of a holistic unit comprising a combination of one or more items from the list: image, video, text, sound.

15. A mobile communication, comprising circuitry configured to:
receive positioning information representing a geographical location;
calculate data representing a first route from said received positioning information, said first route having a starting point, a current point, and an ending point;
store data representing said first route;
capture a first set of content information comprising components of contents information and associating said components of content information with components of said received positioning information;
associate said first route with said first set of content information; and
store data representing an association of said components of said first set of captured content information and said components of acquired positioning information.

16. The mobile communication device according to claim 15, further comprising circuitry configured to receive a second route, wherein said second route is associated with a second set of captured content information.

17. The mobile communication device according to claim 15, further comprising circuitry configured to:
receive a pre-defined map;
indicate at least one of said first and said second route on said pre-defined map thereby creating a personalised map;
indicate said at least one set of content information of said at least one route and said components of captured positioning information together on said personalised map; and
store said personalised map.

18. The mobile communication device according to claim 15, further comprising a device, from the list: timing device, positioning device, motion sensing device, for controlling said receiving of positioning information.

19. The mobile communication device according to claim 15, further comprising a device for receiving said captured positioning information continuously.

20. A method in a server for processing personalised maps, comprising:
providing positioning information to a mobile communication device;
providing a pre-defined map to a mobile communication device;
receiving at least one route from said mobile communication device;
receiving at least one set of holistic units of captured content information associated with said positioning information from said mobile communication device, said content information comprising a combination of one or more items from the list: image, video, text, sound;
associating said pre-defined map, said received at least one route, and received said at least one set of holistic units of captured content information to form a personalised map;
sharing said personalised map between said mobile communication device and one or more devices, from the list: a mobile communication device, a local device, a computer; and
combining at least one personalised map into one single cardinal personalised map.

21. The method in a server for personalised maps according to claim 19, further comprising indicating said at least one personalised map on a display.

22. A server comprising circuitry to perform a method according to claim 20.

23. A system for communicating personalised maps, comprising a communications system, at least one mobile communication device according to claim 1 and at least one server according to claim 1, wherein said communications system facilitates the communication between said at least one mobile communication device and said at least one server.

24. A computer program product, comprising computer program code stored on a computer-readable storage medium which, when executed on a processor, carries out the method according to claim 1.

25. A computer program product, comprising computer program code stored on a computer-readable storage medium which, when executed on a processor, carries out the method according to claim 20.
